(19) United States
(12) Patent Application Publication
(10) Pub. No.: US 2009/0041311 A1
(43) Pub. Date: Feb. 12, 2009

(54) Facial recognition based content blocking system

(76) Inventor: Jon Hundley, Cupertino, CA (US)

Correspondence Address: MATTHEW E. BURR, 620 CONGRESS AVENUE, STE 320, AUSTIN, TX, 78701, US

(21) Appl. No.: 11/891,305

(22) Filed: Aug. 9, 2007

(51) Int. Cl. G06K 9/00; H04N 5/445; H04N 7/16; H04N 7/173

(52) U.S. Cl. 382/118; 348/564; 725/127; 725/28; 725/98; 348/E05.096; 348/E05.099

(57) ABSTRACT

Methods and apparatus for blocking content. In one embodiment, an image is examined for pre-selected body portions. If the image contains a body portion (e.g. an image of a face larger than a pre-selected portion of the image) access is allowed. Otherwise, the content may be obscured or blocked with a translucent object either before or after an initial transmission. The image may be part of a video stream such as an instant messaging, web-cam, or video chat room session. The image may be sent or received and-may be examined with facial recognition technology. Additionally, the image may be tagged to indicate whether it contains the sub-image. In addition, the method may be incorporated in a computer program associated with a particular instant messaging program (e.g., the program is a Miranda IM add-on). Server, network, and client computers which may incorporate portions of the program are also provided.

### TECHNICAL FIELD

This disclosure relates to electronic communications and more particularly to content blocking for instant messaging systems that include video streaming.

### BACKGROUND

Live video streams, particularly when they occur over the Internet, pose several problems for live video communities because it is difficult or impossible to monitor and remove inappropriate or adult content (e.g., violent or pornographic images) in real time, that is, as the communications occur. When a user receives such unwanted content, its presence can have a deleterious effect on the user's enjoyment of the viewing experience. Moreover, the presence of children and other susceptible individuals at the receiving site aggravates these problems and creates other problems posed by such content.

In the meantime, the video transmission protocols and corresponding functionality have also proliferated. Whereas e-mail used to be the norm for sending these unwanted images, now these images can be sent via instant messaging, video chat rooms, and web-cam protocols to name a few of the available protocols. To compound the problem, recent advances in web-cam technology have made production of such images significantly easier. For instance, initially, a digital camera typically cost many hundreds of dollars. Presently, $30 cameras are not only available but are in wide spread distribution. Thus, those who might wish to create and send such images have the physical means to do so. Similarly, web-cam software packages have also proliferated thereby making the transmission of such images a turnkey operation. While certain sites and senders can sometimes be identified and blocked, such techniques do not work in all situations. For instance, offending senders may change their identities or remain anonymous.

Thus, the inventors recognized a need for improved content blocking particularly with regard to live video events.

### SUMMARY

The “Faces Only” embodiment of the present disclosure helps to solve the aforementioned problems, among others, by blocking any live video that does not contain a human face. The current embodiment provides for the monitoring of live video images for human faces to prevent viewing of any image that does not include a human face. If no human face is available, the video image is blocked from the user. Outgoing video images may also be monitored for a human face. If no face is available then the transmission of the video is blocked. The current embodiment may also analyze the video feed using facial recognition technology to determine if a face is present. If it is determined that the feed should be blocked a translucent image may be applied over the video image so that the user can guess at a general idea of the content under the translucency. However, the user will not see the video image in full or clearly. The level of the translucency can be set by the user and the blocking feature can be completely disabled by the user. In addition, the user can choose to turn off the translucency if the user feels the image under the translucency may be appropriate. In other embodiments, the image of the face can be a certain size or fill up a certain percentage of the image before the translucency is removed. The current embodiment can be used to monitor a live video environment such as a live web-cam or video chat room broadcast to try to prevent inappropriate or adult content.

In part to reduce the processing associated with monitoring numerous video streams for faces, other embodiments use a special technique in which tags are given to video streams by a server where over 1,000 or more video streams can be checked for faces. The tagged streams may then be blocked with a translucency prior to viewing by users viewing the video via a client computer. In the current embodiment, the server checks the video stream to see if it contains a face or not. If it does not contain a face, the video stream is tagged as not having a face present and the user views the video stream with a translucent image over it. If the video stream has a face, the translucent image is not present over the live video stream according to the current embodiment.

In another embodiment, an image is examined for one or more pre-selected body portions. If the image contains a body portion (e.g. an image of a face larger than a pre-selected portion of the image), or contains no body portions, access is allowed. Otherwise, the content may be blocked with a translucent object. A “face rectangle” embodiment may obscure the image except for the portion within a rectangle that contains a detected face. The image may be part of a video stream or live video event such as an instant messaging, web-cam, or video chat room session. The image may be sent or received and may be examined with facial recognition technology. Additionally, the image may be tagged to indicate whether it contains the sub-image of the body portion. In addition, the method may be incorporated in a computer program associated with a particular instant messaging program (e.g., the program is a Miranda IM add-on). Additionally, server, network, and client computers may incorporate portions of the program which may be distributed among the various platforms or devices.

In yet another embodiment a machine readable medium includes executable instructions stored thereon for determining whether a live video image contains a sub-image of a pre-selected portion of a body. The medium also includes instructions for at least partially blocking the image if the image does not contain the sub-image of the pre-selected body portion and for allowing access to the image if the image contains the sub-image of the pre-selected body portion. Optionally, the medium may also include instructions for determining the size of the sub-image relative to the image and allowing access to the image if the sub-image is at least a pre-determined size relative to the image. Additionally, instructions for overlaying at least a portion of the image with a translucent object and adjusting the translucency of the object may also be provided. Of course, instructions can likewise be provided for allowing a user to disable the blocking. Moreover, the image can be associated with an event such as an instant messaging session, a web-cam transmission, a web-cam viewing, or a video chat room session.

The machine readable medium of the current embodiment may also include instructions for tagging the image to indicate whether the image contains the sub-image. Further, the machine readable medium can include executable instructions for sending or receiving the image with the tag. Additionally, the machine readable medium may include instructions for determining whether the tag indicates that the image contains the sub-image and blocking at least a portion of the image if so. In other embodiments, the medium can include instructions for interfacing with an instant messaging system.

In still another embodiment, a server is provided which includes a data source, a network interface, a machine readable medium, a data destination, and a processor. The machine readable medium includes executable instructions for receiving at least one live video image from the data source and determining whether the live video image contains a sub-image of a pre-selected portion of a body. The medium may also include instructions for at least partially blocking the live video image if the live video image does not contain the sub-image of the pre-selected body portion thereby creating a viewable image. As well, the machine readable medium can include instructions for allowing access to the live video image if the live video image contains the sub-image of the pre-selected body portion thereby creating the viewable image. Of course, the machine readable medium can also have executable instructions for sending the viewable image to the data destination. Optionally, the network can be the data source and the destination. In addition, the machine readable medium can include instructions for blocking the image by tagging the viewable image.

Similarly, another embodiment provides a client computer. In the current embodiment, the executable instructions stored on the machine readable medium include instructions for receiving at least one live video image from the data source and determining whether the live video image contains a sub-image of a pre-selected portion of a body. The instructions may also include instructions for at least partially blocking the live video image if the live video image does not contain the sub-image containing the pre-selected body portion thereby creating a viewable image. Additionally, the machine readable medium can include instructions for allowing access to the live video image if the live video image contains the sub-image containing the pre-selected body portion thereby creating a viewable image. Optionally, the instructions can also provide for overlaying at least a portion of the live video image with an adjustable translucent object and for disabling the blocking. Another option allows the live video image to be tagged to indicate whether the live video image contains the sub-image. In which case, the machine readable medium can include executable instructions for determining whether the tag indicates that the live video image contains the sub-image and blocking at least a portion of the live video image if so. Of course, as another option, the network may be the data source. In yet other embodiments, systems that include various clients and servers are also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of a communications system constructed in accordance with an embodiment of the present disclosure.

FIG. 2 is a diagrammatic illustration of a live video image constructed in accordance with another embodiment of the present disclosure.

FIG. 3 is a flowchart of a method practiced in accordance with another embodiment of the present disclosure.

FIG. 4 is a flowchart of another method practiced in accordance with another embodiment of the present disclosure.

FIG. 5A is a transmitter side flowchart of a yet another alternative embodiment of a method of the present disclosure.

FIG. 5B is a receiver side flowchart of a yet another alternative embodiment of a method of the present disclosure.

### DETAILED DESCRIPTION

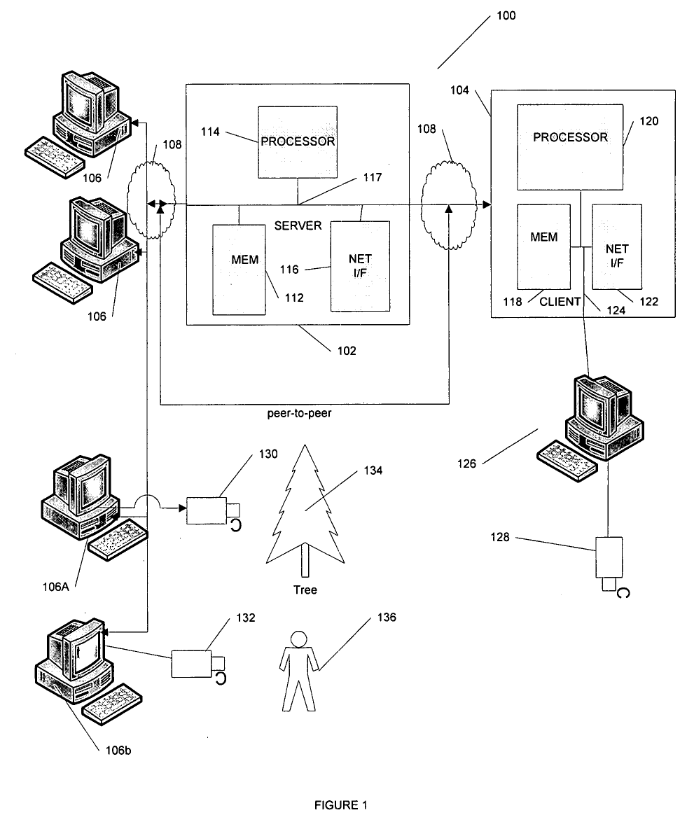

FIG. 1 is a diagrammatic illustration of a communications system constructed in accordance with an embodiment of the present disclosure. Reference numeral 100 generally designates a communications system embodying features of the present disclosure. The system 100 typically includes a server 102, a client computer 104, and a variety of other client computers 106 which in this context will serve as examples of data sources. Of course, the client 104 may also represent a data source for the system 100 (including itself 104). These computers 102, 104, and 106 may be in communication with one and other through a client-server based network 108 such as a LAN, WAN, or the Internet. The computers 102, 104, and 106 may also communicate across a peer-to-peer (P2P) communication system as well as systems employing a variety of other architectures which possess the capability of transferring information between the various communications devices. Nor is the disclosure limited to computing devices such as computers 102, 104, and 106. Rather, it is envisioned that any device capable of displaying content may be used in conjunction with the present disclosure.

With continuing reference to FIG. 1, the server 102 may be a stand alone personal computer configured for receiving requests from clients 104, a group of such computers, a dedicated mainframe computer, or any number of other devices which possess the capability of sending and receiving content. The server 102 typically includes a memory 112, a circuit (e.g., a processor) 114, and some interface 116 to the network 108. These components 112, 114, and 116 of the server 102 typically communicate along one, or more, internal buses 118. Furthermore, these components 112, 114, and 116 work together as will be described herein. For instance, the network interface 116 facilitates communications between the microprocessor 114 (and memory 112) and the other computers 104 and 106 on the network 108. For another example, the memory 112 may not only may store the executable instructions which the processor 114 executes to perform useful functions but may also be used to store content (e.g., video images) for later use or processing.

As with the server 102, the client 104 is also frequently constructed with a memory 118, a microprocessor 120, a network interface 122, and an internal bus 124. Additionally, the client 104 often includes a display 126 and a camera 128. Data sources (e.g., client computers) 106A and 106B are similarly shown with cameras 130 and 132 connected to those computers. The clients 104 are typically distributed throughout a geographic region at homes, offices and other locations although this arrangement need not be the case. In contrast, a central facility such as an Internet Service Provider (ISP), instant messaging (IM) system provider, or Internet chat room host often furnishes the server 102 and network 108 or 110.

In operation, the data sources 106 of FIG. 1 provide images of objects and people at the locations where these computers 106 are located. In addition, the data sources 106 may playback previously stored video images and may even re-transmit video images obtained from other sources. For instance, the data source 106A can transmit a live video image of an inanimate object (e.g., a tree 134 or coffee pot). With increasing frequency though, data sources 106 send (or transmit) video images of its user 136 across the network 108. The server 102 receives these images and forwards them to requesting users at the client 104. Indeed, the user at client 104 may be involved in a video instant messaging session with the user 136 at client 106B. In any case, the images are captured by a camera 128, 130, or 132 and are typically transmitted by computer 104 or 106 across the network 108 or 110. The video image can then be forwarded by the server 102, and received by the clients 104.

One exemplary video messaging system 100 is available from Camshare, LLC of Austin, Tex. and at the Internet address camfrog.com. The Camshare system 100, known by the brand Camfrog®, allows users to register, log in, and then download a program that allows the user to connect to the system 100 thereby converting the user's computer into a client 104 in the Camshare system 100. Once connected, the user can then select a video chat room to join. In addition, once in the chat room, the user can select visible users who have a web cam 130 or 132 in use and view them via the system 100. However, any video messaging system 100 (and numerous other types of systems) may be used in conjunction with the current embodiment.

Of course, the network 108 or 110 and the computers 102, 104 and 106 connected thereto may use any protocol with data transport functionality. Exemplary embodiments of the present disclosure use either TCP/IP (Transmission Control Protocol/Internet Protocol) or SCTP (Stream Control Transmission Protocol). However, the present disclosure is not limited to embodiments using these protocols. Furthermore, it is envisioned that any protocol, system, or network that includes data transfer functionality may be used in conjunction with the present disclosure.

As set forth previously, the widespread availability of content creation and distribution technology presents several problems to the community of users of systems such as system 100 of FIG. 1. For instance, some particular users 136 might attempt to send images across the network 108 which other users might find harmful, obscene, or otherwise offensive. The problem is particularly acute with regard to the transmission of live video images (e.g., web-cam casts and video chat room sessions) because no editing has historically been possible prior to the viewing of these offensive images. Accordingly, the inventors recognized a need for a method of blocking offensive video mages in real-time and prior to their receipt or even (re)transmission. However, the disclosure is not limited to live video images. Rather, any content (such as still images) may be blocked according to the principles of the present disclosure.

In addition to the system 100 of FIG. 1, the present disclosure contemplates programs stored on machine readable medium to operate computers and other media playing devices according to the principles of the present disclosure. Machine readable media include, but is not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media includes transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

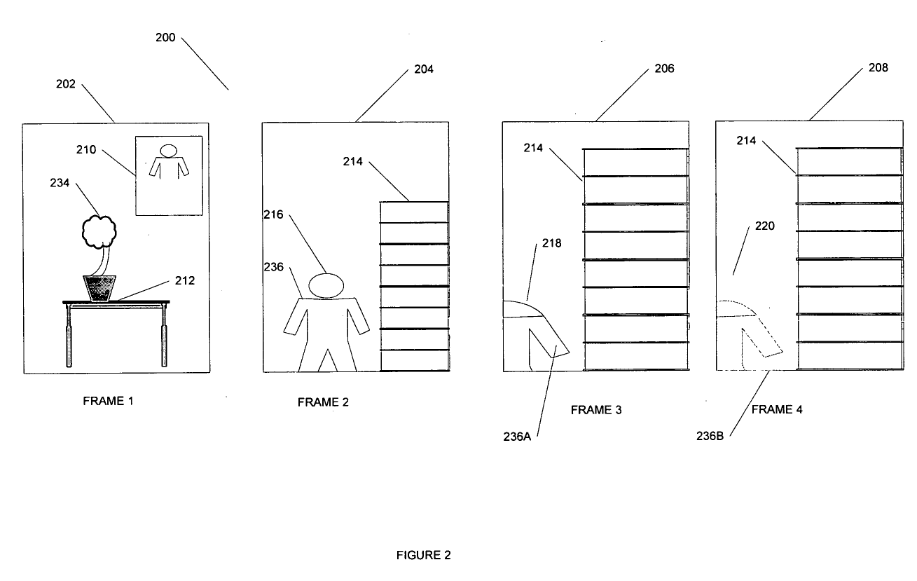

FIG. 2 is a diagrammatic illustration of a live video image constructed in accordance with another embodiment of the present disclosure. By way of further illustration, FIG. 2 shows several frames, or images, obtained from one, or more, live video images 200 which the system of FIG. 1 may transport. Of course, the images may be formatted, stored, transmitted, or otherwise exist in any format such as JPG, GIF, TIFF, PNG, BMP, PSD, PSP, MPG, MPEG, HDTV, ASF, WMA, WMV, WM any existing or future format with similar functionality such as the exemplary formats listed herein. Thus, while FIG. 2 schematically illustrates “frames,” it will be understood that the present disclosure is in no way limited by “framing.” Nor is the disclosure limited by the manner in which the images are obtained. Thus, the frames may be captured, “grabbed,” or sampled in any manner without departing from the scope of the disclosure.

With continuing reference to FIG. 2, the drawing shows four exemplary frames 202, 204, 206, and 208 which can be transported over the system 100 of FIG. 1. The first frame, frame 202, illustrates an image taken by camera 130 of flowerpot 234 and other objects in the background (e.g., a photograph 210 and a table 212). Each of the objects 210, 212, and 234 causes a corresponding sub-image to appear in the overall image 202. Taken alone, or together, these sub-images 210, 212, and 234 may, or may not, be offensive to the recipient independently of the other sub-images with which they appear. Likewise, images 204, 206, and 208 contain various instances of sub-images 214 and 236. In these images 204, 206, and 208 the sub-image 214 is that of a desk or book shelf whereas the sub-images 236 are that of user 236 (as imaged by camera 106B) captured at different times during the video image. In image 204, the user 236 appears to be standing or perhaps sitting in front of the camera 132. Thus, nothing offensive appears in the image 204 as illustrated by FIG. 2. However, between the creation of images 204 and 206 changes can occur in the captured scene which might introduce potentially offensive content into the image 206. Schematically, this change is represented by the image 206 of the user changing to that of the user standing up in close proximity to the camera with the user's head and shoulders disappearing from the image.

More specifically, it is known that certain users might present offensive scenes to the camera 106B. These types of scenes (e.g., violent and sexually explicit content) unfortunately occur from time to time with no way being heretofore possible of stopping or blocking their creation or transmission. However, the inventors have noted that images of such scenes often fail to include images of the face of the user (or others). Instead, other body parts may be present in the image 206 as illustrated by sub-image 236A of FIG. 2. Thus, the inventors have found that one useful method of detecting potentially offensive scenes contained within an image 206 is to examine the image 206 for the inclusion of a sub-image of a face. Further, the inventors have noted that those images 204 containing sub-images of a face(s) are usually inoffensive. In contrast, the authors have noted that images 206 containing sub-images of portions of the human body other than a face (and containing no sub-images of faces) have a higher likelihood of being offensive. Thus, in general, it is possible to select a group of body portions (e.g., a face) which, if shown in an image, indicate the likely presence of an inoffensive image. Of course, it is also possible to select a group of body portions which, if shown in an image, indicate the possible presence of an offensive image.

However, several advantages flow from using a face sub-image as the indicator of potential offensiveness. First, face recognition technology is readily available with competing algorithms being offered from a number of sources. Second, databases of facial images are also readily available. In contrast, databases of images of other body portions are not as available, at least to the extent that the images have been prepared for use in machine vision systems which are analogous to facial recognition databases. However, the inventors envision building such databases to allow other portions of the body to be used as indicators of potential offensiveness.

With reference again to FIG. 2, an examination of images 204 and 206 reveals that because image 204 contains a sub-image 216 of the face of user 136, image 204 possesses a relatively low probability of being offensive. In contrast, image 206 contains a sub-image 236A of the user 136 standing in close proximity to the camera 132. As a result, the user's face fails to appear in the overall image 206 captured by camera 132 even though other body portions (e.g., relatively in-offensive arm pit 218) appear in the image 206. Of course, it is possible to imagine more offensive sub-images that could appear in the overall image 206 (e.g., those that are sexually explicit) that need not be further elaborated herein. Nonetheless, the image 206 is identified as having a high probability of being. Accordingly, if any (or all) of the devices 102, 104, and 106 (see FIG. 1) along the image's transport path could block the image 206 the chances that a viewer would be offend by the image 206 are eliminated and, if not, at least reduced to more reasonable levels.

With the potentially offensive content identified, any form of content blocking could be used to protect the recipient from the image 206. For instance, once detected, the (re)transmission of the potentially offensive image could simply be stopped or an opaque object could be placed over the image 206 before it is transmitted, forwarded, or displayed. However, it is possible that many images, such as that in frame 206A, could contain no faces yet still be in-offensive. In other words, false positives could result in undesirable blocking of content. Thus, an embodiment of the present disclosure allows the image 206 to be obscured instead of completely blocked or completely covered with an opaque object. For instance, the image can be intentionally blurred or pixilated to obscure the potentially offensive content.

In the alternative, the inventors have found that overlaying potentially offensive images with a translucent object is sufficient to reduce the likelihood to reasonable levels that a potential viewer will be offended by the under lying content. In one embodiment, the object is just transparent enough that the user can obtain a general idea of the underlying content without viewing enough detail to become offended. Such a translucent object is represented in image 208 by object 220. Furthermore, the translucent object 220 illustrated in FIG. 2 can cover all, or just a portion, of the image 208. In another embodiment, a sub-image of a face 216 must occupy at least a pre-determined portion of the overall image 204 for the translucency, once applied, to be removed. Of course, the user can select the size of the sub-image, the body part to search for, the level of translucency of the object, and whether the blocking is enabled or disabled.

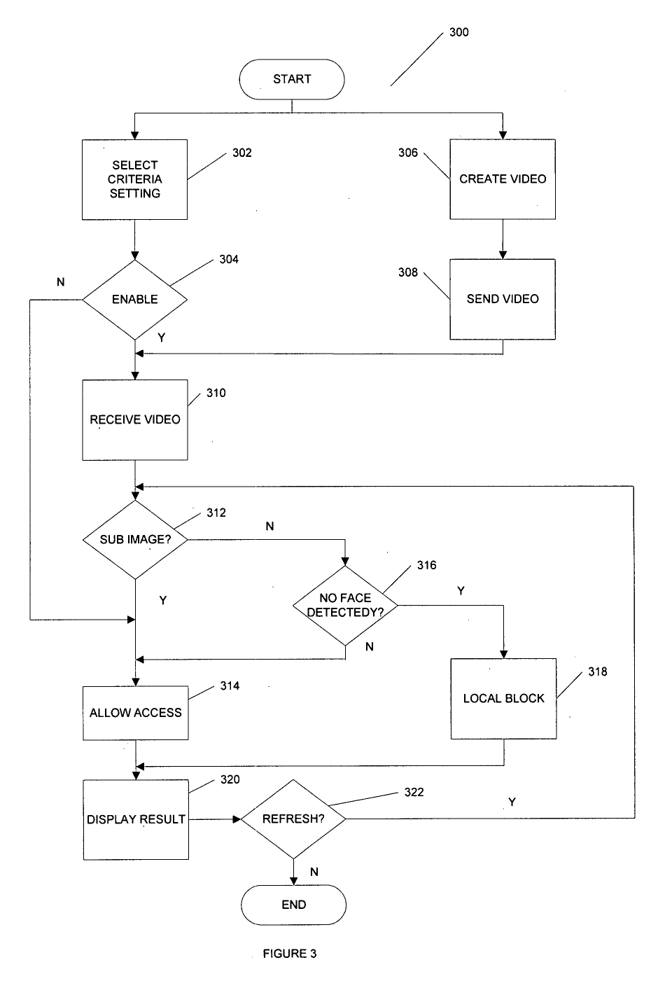

FIG. 3 is a flowchart of a method practiced in accordance with another embodiment of the present disclosure. Method 300 of processing video images practiced in accordance with the principles of the present disclosure is illustrated. The method 300 may begin with a user selecting the criteria that triggers content blocking. See reference 302. For example, a user can select which body portion (e.g., a face) allows access to the content if it is present in the overall image. The user can also set what fraction or percentage of the overall image that the sub-image must fill before it is deemed large enough to indicate that the content is likely to be inoffensive. At this stage, or at any step in the method 300, the user may also enable or disable content blocking as indicated by reference 304.

In the meantime, another user may be creating image(s) (see operation 306) and sending them to the first user (and perhaps others). At some point, the first user begins receiving the images (see reference 310). At this time, each image can be examined to determine whether it contains a sub-image of the pre-selected body portion as shown by decision 312. If it does contain the sub-image then it may be deemed as being potentially inoffensive. Accordingly, operation 314 shows access being granted to the image. Otherwise, if the sub-image is not present, then the video image might contain either (1) other body portions or (2) no body portions at all. Thus, another determination can be made regarding whether other body portions are present in the video image. See operation 316. If no body portions are present (e.g., the imaged scene shows only inanimate objects), then access may be allowed in operation 314.

Otherwise, operation 318 can block access to the video image. More particularly, a translucent object may be shaped, sized, and positioned over the video image in a manner that may be pre-selected by the user. In another embodiment, the user is also able to set the opacity (or degree of translucency) of the translucent object. For instance, the user may wish to obscure most of the detailed imagery in the image yet still be able to gather a general idea of what is being shown. Thus, the user can obtain a general feel for how offensive the material might be and gradually lighten the translucent object until the nature of the under lying content is revealed. In any event, the image may be viewed in operation 320 with, or without, the blocking in place as determined by operations 314 and 318. Of course, as new video images come in, or at a frequency selected by the user, the block can be refreshed by returning to operation 312 as shown by decision 322. In yet another method practiced in accordance with the principles of the present disclosure, the determination of whether to block the image (operations 312, 314, 316, and 318) can be applied as the image is being captured or before the image is sent.

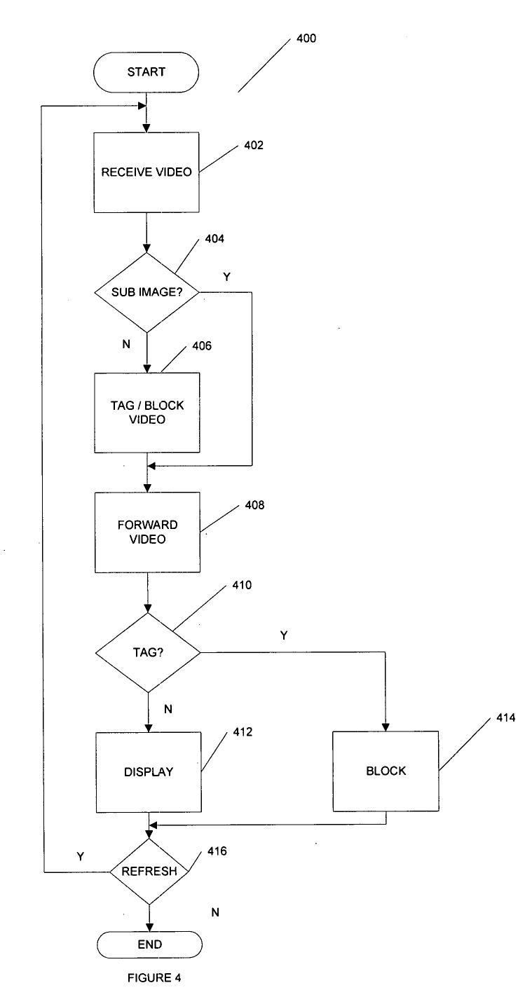

FIG. 4 is a flowchart of another method practiced in accordance with another embodiment of the present disclosure. FIG. 4 illustrates another method 400 of processing images practiced in accordance with the principles of the present disclosure. FIG. 4 differs from FIG. 3 in that method 400 can be used to allow a server (or other third party) to block potentially offensive content. Method 300 of FIG. 3 can be used by a user or client to block incoming, un-examined content. Of course, both methods 300 and 400 can be used together to (1) block content at its source or creation, (2) block its (re)transmission, and (3) block its receipt.

With continuing reference to FIG. 4, the method 400 may begin with the receipt of a video image by, for instance, a video chat room service provider. See reference 402. The video image may then be examined to determine whether the video image contains the sub-image in operation 404. If the video image does not contain the sub-image then a tag, or flag, associated with the video image can be set to indicate that the video image might contain offensive material. See operation 406. In this manner, as will be further described herein, the video image can be blocked.

The video image may be forwarded to a recipient in operation 408. In operation 410, the recipient may examine the tag to determine whether the video image has been deemed to contain potentially offensive material. See operation 410. If the tag has been set to indicate that the video image is probably not offensive then operation 412 may be executed to allow access to the video image. Otherwise, the video image may be blocked with a translucent object as shown at reference 414. In addition to examining the tag, the recipient may also examine the video image for the presence of the sub-image. Of course, the content blocking can be refreshed upon the receipt of another frame of the video image or at other times as desired by the user. See operation 416.

If the block is to be refreshed, the method 400 returns to either operation 402, 404, or 410 depending oh whether a new video image (or frame) has been received and whether the user desires the server or recipient to refresh the block. Because the server determines whether the video image contains the sub-image in the current embodiment, the server performs the processing to recognize the pre-selected body portion. In contrast, the recipient, or client, merely examines the tag processing upon receipt of the video image which requires very little processing. Moreover, the application resident on the recipient may be quite simple with relatively few lines of code and associated memory requirements.

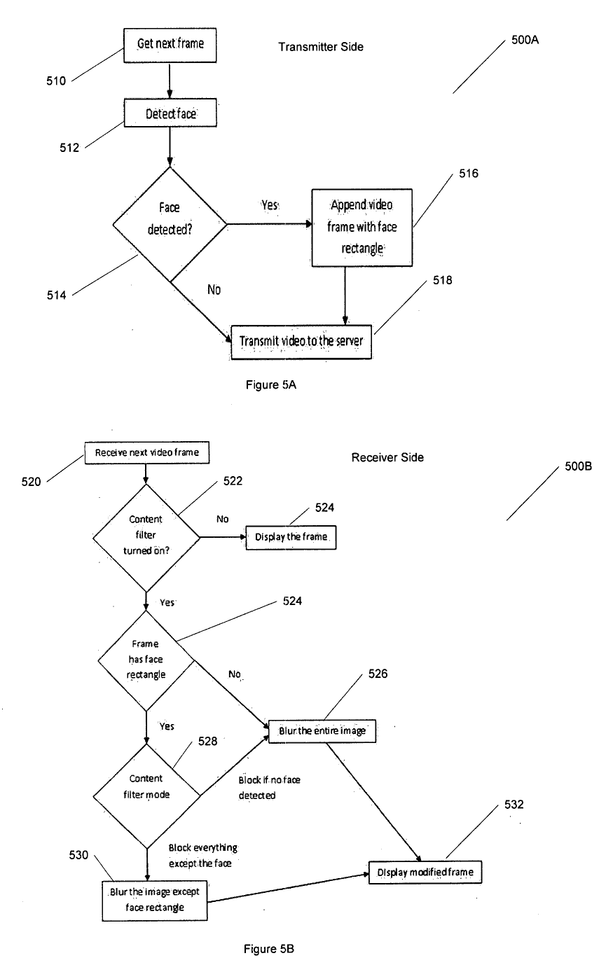

FIG. 5A is a transmitter side flowchart of a yet another alternative embodiment of a method of the present disclosure. An electronic transmitter may execute a get next frame instruction 510 to detect face 512. Decision module 514 queries whether a face has been detected. If a face has been detected then append video frame with face 516 and transmit to server 518. If no face was detected then transmit video to server 518 without appended video.

FIG. 5B is a receiver side flowchart of a yet another alternative embodiment of a method of the present disclosure. Face detection alone may not catch objectionable content because a full frontal image may not be blocked since such an image would still contain a face. To address such a situation, specific embodiments may use a “face rectangle” to obscure everything not inside the rectangle.

For example, as illustrated in FIG. 5B, an electronic receiver may execute a receive next video frame instruction 520. Decision module 522 queries whether a content filter is turned on. If a content filter is not on, then display the frame 516. If a content filter is turned on then determine 524 whether the frame has a face rectangle. If the frame does not have a face rectangle then blur or render translucent the image 526 and display 532 the modified frame. If the image has a face rectangle then apply content filter mode 528 and blur the image 526 for displaying the modified frame 532 or block the image if no face is detected. Content filter mode 528 may blur or render translucent the image except for the face rectangle 530 and display modified frame 532.

The user in specific embodiments of the present disclosure may control translucence, blurring, pixilation or other ways of obscuring the image. For example, a slider may appear when a cursor rolls over the image to allow the user to adjust the degree of blurring or translucence. Additionally, a set may be provided to allow the user to adjust the translucency for all or for selected video windows.

Specific embodiments contemplate that a user may disable image blocking or translucency globally or on a contact-by-contact basis. For example, if a contact is on the user's buddy list, image obscuring may be selectively turned off for that contact.

Any one or more of a variety of means known to those skilled in the art may perform face recognition of the present disclosure. For example, specific embodiments of the present disclosure draw on face detection features from an open source library available online at http://www.intel.com/technology/computing/opencv/. An overview of the library may be found at http://www.intel.com/technology/computing/opencv/overview.htm. Sourceforge.net is also an online resource related to computer vision technology.

The use of the present disclosure described above with reference to FIGS. 1-5B provides many advantages over the prior art including the ability to block potentially offensive content in real-time. Additionally, the recipient of the blocked content may still form a general idea of the content of a blocked video image without being offended. Moreover, because the user may still obtain an impression of the blocked content, the user can access (via, for example, disabling the blocking mechanism) inoffensive content which might have been deemed potentially offensive (i.e., false positives). Furthermore, a centralized service provider can examine thousands of video images in real-time and provide the blocking service for a like number of potential recipients.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of blocking content comprising:
determining whether a live video image contains a sub-image of a pre-selected portion of a body;
at least partially blocking the image if the image does not contain the sub-image of the pre-selected body portion; and
allowing access to the image if the image contains the sub-image of the pre-selected body portion.

2. The method of claim 1 wherein the pre-selected body portion is a face.

3. The method of claim 1 further comprising determining the size of the sub-image relative to the image and allowing access to the image only if the sub-image is at least a pre-determined size relative to the image.

4. The method of claim 1, wherein the blocking includes overlaying at least a portion of the image with a translucent object.

5. The method of claim 4 further comprising allowing a user to set the degree of translucency of the object.

6. The method of claim 1 further comprising allowing a user to disable the blocking.

7. The method of claim 1 wherein the image is associated with an event selected from the group consisting of an instant messaging session, a web-cam transmission, a web-cam viewing, and a video chat room session.

8. The method of claim 1 further comprising tagging the image to indicate whether the image contains the sub-image.

9. The method of claim 8 further comprising sending the image with the tag.

10. The method of claim 8 further comprising receiving the image with the tag.

11. The method of claim 10 further comprising determining whether the tag indicates that the image contains the sub-image and blocking at least a portion of the image if so.

12. The method of claim 1 further comprising allowing access to the image if the image contains no sub-image of a body portion.

13. The method of claim 1 further comprising the determining occurring before an initial transmission of the image.

14. A machine readable medium comprising executable instructions stored thereon for:
determining whether a live video image contains a sub-image of a pre-selected portion of a body;
at least partially blocking the image if the image does not contain the sub-image of the pre-selected body portion; and
allowing access to the image if the image contains the sub-image of the pre-selected body portion.

15. The machine readable medium of claim 14 further comprising executable instructions for determining the size of the sub-image relative to the image and allowing access to the image if the sub-image is at least a pre-determined size relative to the image.

16. The machine readable medium of claim 14, wherein the executable instructions for blocking further comprise executable instructions for overlaying at least a portion of the image with a translucent object.

17. The machine readable medium of claim 16 further comprising executable instructions for allowing the user to set the degree of translucency of the object.

18. The machine readable medium of claim 14 further comprising executable instructions for allowing a user to disable the blocking.

19. The machine readable medium of claim 14 wherein the image is associated with an event selected from the group consisting of an instant messaging session, a web-cam transmission, a web-cam viewing, and a video chat room session.

20. The machine readable medium of claim 14 further comprising executable instructions for tagging the image to indicate whether the image contains the sub-image.

21. The machine readable medium of claim 20 further comprising executable instructions for sending the image with the tag.

22. The machine readable medium of claim 20 further comprising executable instructions for receiving the image with the tag.

23. The machine readable medium of claim 22 further comprising executable instructions for determining whether the tag indicates that the image contains the sub-image and blocking at least a portion of the image if so.

24. The computer program of claim 14 further comprising executable instructions for interfacing with an instant messaging system.

25. A server comprising:
a data source;
a network interface for communicating with a network;
a machine readable medium including executable instructions stored thereon for
receiving at least one live video image from the data source,
determining whether the live video image contains a sub-image of a pre-selected portion of a body,
at least partially blocking the live video image if the live video image does not contain the sub-image of the pre-selected body portion thereby creating a viewable image, and
allowing access to the live video image if the live video image contains the sub-image of the pre-selected body portion thereby creating the viewable image;
a data destination, the machine readable medium further including executable instructions for sending the viewable image to the data destination; and
a circuit for executing the executable instructions and being in communication with the data source, the machine readable medium, and the data destination.

26. The server of claim 25 wherein the network is the data source and the data destination.

27. The server of claim 25 wherein the machine readable medium further includes executable instructions for blocking the image by tagging the viewable image.

28. A client comprising:
a data source;
a network interface for communicating with a network;
a machine readable medium including executable instructions stored thereon for
receiving at least one live video image from the data source,
determining whether the live video image contains a sub-image of a pre-selected portion of a body,
at least partially blocking the live video image if the live video image does not contain the sub-image containing the pre-selected body portion thereby creating a viewable image, and
allowing access to the live video image if the live video image contains the sub-image containing the pre-selected body portion thereby creating a viewable image;
a display, the machine readable medium further including executable instructions for displaying the viewable image on the display; and
a circuit for executing the executable instructions and being in communication with the data source, the machine readable medium, and the display.

29. The client of claim 28 wherein the network is the data source.

30. The client of claim 28 wherein the executable instructions for blocking further comprise executable program instructions for overlaying at least a portion of the live video image with a translucent object.

31. The client of claim 28 wherein the machine readable medium further includes executable instructions for allowing the user to set the degree of translucency of the object.

32. The client of claim 28 wherein the machine readable medium further includes executable instructions for allowing a user to disable the blocking.

33. The client of claim 28 wherein the live video image is tagged to indicate whether the live video image contains the sub-image, the machine readable medium further including executable instructions for determining whether the tag indicates that the live video image contains the sub-image and blocking at least a portion of the live video image if so.

34. A system comprising:
a server including:
a data source,
a first machine readable medium including executable instructions stored thereon for receiving at least one live video image from the data source, and
a first circuit for executing the executable instructions and being in communication with the first machine readable medium; and
a client in communication with the server and including:
a second machine readable medium including executable instructions stored thereon for receiving live video images from the server,
a display, the second machine readable medium further including executable instructions for displaying live video images on the display; and
a second circuit for executing the executable instructions and being in communication with the second machine readable medium, the first machine readable medium including executable instructions for sending live video images to the client computer,
at least one of the first and second machine readable media further including executable instructions for:
determining whether a live video image contains a sub-image of a pre-selected portion of a body,
at least partially blocking the live video image if the live video image does not contain the sub-image of the pre-selected body portion thereby creating a viewable image,
allowing access to the live video image if the live video image contains the sub-image of the pre-selected body portion thereby creating the viewable image, and
sending the viewable image to the client computer if the first machine readable medium includes the executable instructions for determining whether the live video image contains the sub-image of the pre-selected body part.
